(19) United States
(12) Patent Application Publication
(10) Pub. No.: US 2003/0029511 A1
(43) Pub. Date: Feb. 13, 2003

(54) EASI-PLUM-SPI

(76) Inventor: J. Van Hubbard, Washington, DC (US)

Correspondence Address: J. Van Hubbard, 36154 Randle Station SE, Washington, DC, 20020, US

(21) Appl. No.: 09/925,367

(22) Filed: Aug. 10, 2001

(51) Int. Cl. F16L 55/18

(52) U.S. Cl. 138/97; 138/98

(57) ABSTRACT

“EASI-PLUM-SPI offers a great way for home owners and businesses to have their plumbing repairs done in a timely and less intrusive manner. Can you imagine having your busted pipes fixed without having your floors, ceilings, lawns, driveways, or streets torn out or completely up or out. Having your broken pipes sealed off so that you can still safe use water in other parts of your business or while the repairs are being made to major busted water pipes. Less traffic congestion thanks to the many possible expanded uses for the basic patent protected principle of the EAS-PLUM-SPI. Somethings are only too good to be true only when we refuse to make them come true. Lights . . . cameras . . . action . . . satisfaction thanks to the new and next step of plumbing ‘EASI-PLUM-PRO’SPI’.

### CROSS-REFERENCE TO RELATED APPLICATION

Video Plumbing.

### STATEMENT REGARDING FEDERALLY SPONSORED RESEARCH OR DEVELOPMENT

“Not Applicable”

### REFERENCE TO MICROFICHE APPENDIX

“Not Applicable”

### BACKGROUND OF THE INVENTION

EASI-PLUM-SPI has its' strongest application in its' ability to go in and help plumbers to rebuild old pipes without destroying new, old, and homes of historic value.

When correctly used, EASI-PLUM-SPI, will prevent the tearing out of walls, the tearing up of floors and ceilings, the digging up of lawns and some roads.

### BRIEF SUMMARY OF INVENTION

In the field of plumbing, EASI-PLUM-SPI, OFFERS A VAST ADVANTAGE, to go along with the tried and true application of hard work. At one in the same time, viewing and mending, old worn out pipes, busted pipes and/or broken pipes.

This should greatly shorten the time required to mend pipes in need of fixing. EAS-PLUM-SPI, would also limit the damage to homes, lawns, and roads, through the use of its' patent protected double lined video led feed line. While the drilled tipped bore makes its' way through clogged and or blocked pipes, removing and or boring through any debrie, while at the same time laying a new inner lining of pipe. Time is money to everyone in our very mobile generation.

### BRIEF DESCRIPTION OF THE SEVERAL VIEWS OF THE DRAWING

Will submit upon request if needed.

### DETAILED DESCRIPTION OF THE INVENTION

EASI-PLUM-SPI components required: an electrical motorized feeding wheel base. The base can be stationary and or mobile, determined by the size and location of the job being tackled. This wheel feeds a sturdy and durable gauge wire that is fitted with the a drilling tip. The wire and tip are guided through the busted and or clogged pipe by a video camera mounted behind and to the side of the drill tip on a separate washed style sprocket. Attached to the sprocket is the double lined biodegradable tube. Once the probe has completely laid the tubing, the drill tip is heated hot enough to seal the tube's ends to the old pipe. The tip and sprocket, both collapsible, will be reversed and rewind by the electrical wheel. As the collapsible parts are being returned, the fast setting liquid metal is being pumped through the double lined transparent tube. Once the tube is completely filled with the liquid metal, all crossing pipes are drilled and sealed by the heated drill tip. Once the metal is completely set , you have a new and very safe to use relined pipe.

What I claim as my invention is:

1. EASI-PLUM-SPI allows for less time consuming plumbing repair work.

2. EASI-PLUM-SPI allows for less damaging plumbing repair work.

3. EASI-PLUM-SPI is environmental friendly.
